(19) United States
(12) Patent Application Publication
(10) Pub. No.: US 2015/0042800 A1
(43) Pub. Date: Feb. 12, 2015

(54) APPARATUS AND METHOD FOR PROVIDING AVM IMAGE

(71) Applicant: HYUNDAI MOTOR COMPANY, Seoul (KR)

(72) Inventors: Jae Seob CHOI, Hwaseong-si (KR); Eu Gene CHANG, Gunpo-si (KR)

(73) Assignee: HYUNDAI MOTOR COMPANY, Seoul (KR)

(21) Appl. No.: 14/075,678

(22) Filed: Nov. 8, 2013

(30) Foreign Application Priority Data
Aug. 6, 2013 (KR) 10-2013-0092943

(51) Int. Cl. B60R 1/00; H04N 7/18

(52) U.S. Cl. CPC B60R 1/002; H04N 7/181; B60R 2300/105; B60R 2300/101
USPC 348/148

(57) ABSTRACT

An apparatus and a method for providing an around view monitoring (AVM) image include a camera. A communicator transmits and receives a signal with a surrounding vehicle, and receives an AVM image and surrounding information from the surrounding vehicle. An image converter generates an AVM image of the self-vehicle from an image photographed by the camera and converts the AVM image of the surrounding vehicle based on a position of the self-vehicle. A detector detects an overlapped area between the AVM image of the self-vehicle and the AVM image of the surrounding vehicle. An image compositor composites the AVM image of the self-vehicle and the AVM image of the surrounding vehicle by matching the overlapped area between the AVM image of the self-vehicle and the AVM image of the surrounding vehicle.

### CROSS-REFERENCE TO RELATED APPLICATION

This application claims the benefit of priority to Korean Patent Application No. 10-2013-0092943, filed on Aug. 6, 2013 in the Korean Intellectual Property Office, the disclosure of which is incorporated herein in its entirety by reference.

### TECHNICAL FIELD

The present disclosure relates to an apparatus and a method for providing an around view monitoring (AVM) image, and more particularly, to a technology to provide a composite around view monitoring (AVM) image which may secure a wider view.

### BACKGROUND

An around view monitoring (AVM) system of a vehicle provides an AVM image which converts and composites photographed images of the vehicle surroundings. For example, top, bottom, left, and right side images are converted and composited into a top view image such that a driver may observe front, rear, left, and right side views of the vehicle through the AVM image.

However, since the AVM image provides an image which is converted to the top view image, image distortion or a blind area may be generated, and therefore, it may be difficult to recognize the exact scene. In addition, since the AVM image has a narrow visual area, it is difficult to recognize the other areas.

### SUMMARY

The present disclosure provides an apparatus and a method for providing an around view monitoring (AVM) image that provides a composite AVM image which can secure a wider view.

In an aspect of the present disclosure, an apparatus and a method for providing an AVM image provides the AVM image of an area which is difficult to recognize by a self-vehicle by providing the AVM image which is composited with the AVM image of the self-vehicle based on the AVM image and information obtained from vehicle surroundings.

In accordance with an embodiment of the present disclosure, an apparatus for providing an AVM image includes a camera which photographs an image of a self-vehicle's surroundings. A communicator transmits and receives a signal with a surrounding vehicle, and receives an AVM image and surrounding information from the surrounding vehicle. An image converter generates an AVM image of a self-vehicle from the image photographed by the camera and converts the AVM image of the surrounding vehicle based on a position of the self-vehicle by determining a relative position between the self-vehicle and the surrounding vehicle. A detector detects an overlapped area between the AVM image of the self-vehicle and the AVM image of the surrounding vehicle. An image compositor composites the AVM image of the self-vehicle and the AVM image of the surrounding vehicle by matching the overlapped area between the AVM image of the self-vehicle and the AVM image of the surrounding vehicle.

In accordance with another embodiment of the present disclosure, a method for providing an AVM image includes photographing an image of a self-vehicle's surroundings. An AVM image of a surrounding vehicle and surrounding information are received by communicating with the surrounding vehicle. The AVM image of the surrounding vehicle is converted to match based on a position of a self-vehicle by determining a relative position between the self-vehicle and the surrounding vehicle. An AVM image of the self-vehicle and the AVM image of the surrounding vehicle are composited based on an overlapped area by detecting the overlapped area between the AVM image of the self-vehicle generated from the image of the self-vehicle's surroundings and the AVM image of the surrounding vehicle. Then, a boundary area and an empty area of the composited AVM image are corrected.

### BRIEF DESCRIPTIONS OF THE DRAWINGS

The objects, features, and advantages of the present disclosure will be more apparent from the following detailed description in conjunction with accompanying drawings.

FIG. 1 is a block diagram illustrating a configuration of an around view monitoring (AVM) image providing apparatus according to the present disclosure.

FIGS. 2 to 6 are exemplary diagrams explaining an image composition operation of an AVM image providing apparatus according to the present disclosure.

FIG. 7 is a flowchart illustrating an operation flow for an AVM image providing method according to the present disclosure.

### DETAILED DESCRIPTION

Hereinafter, exemplary embodiments of the present described will be described with reference to the accompanying drawings. In the following description, a detailed description of known functions and configurations incorporated herein will be omitted.

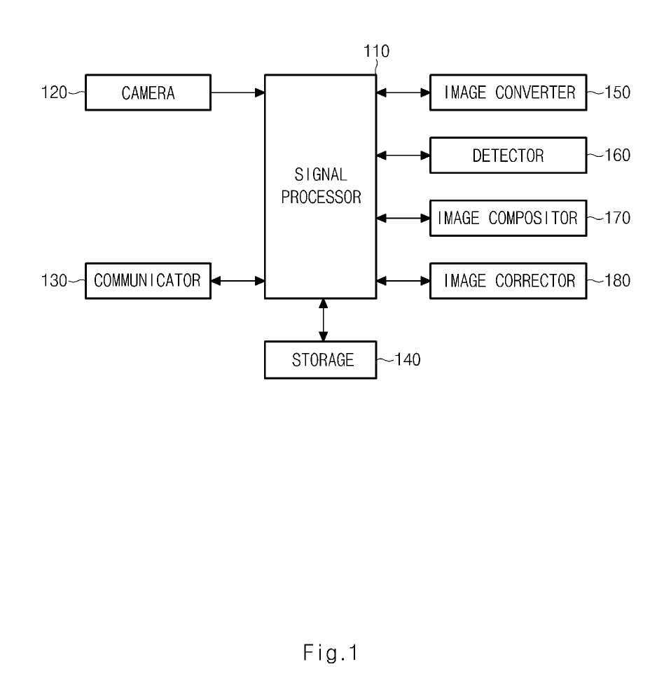

FIG. 1 is a block diagram illustrating a configuration of an around view monitoring (AVM) image providing apparatus according to the present disclosure. Referring to FIG. 1, an AVM image providing apparatus according to the present disclosure may include a signal processor 110, a camera 120, a communicator 130, a storage 140, an image converter 150, a detector 160, an image compositor 170, and an image corrector 180. The signal processor 110 may process a signal which is delivered between each unit of the AVM image providing apparatus.

The camera 120 is mounted in a vehicle and may photograph an image of the vehicle's surroundings. The camera 120 may be plurally mounted, for example, may be mounted in a front, a rear, a left, and a right side of the vehicle. The images of the front, rear, left, and right side of the vehicle photographed by the camera 120 may be delivered to the image converter 150 to generate an around view monitoring (AVM) image.

The communicator 130 may support a communication interface for a vehicle to vehicle (V2V) communication. The communicator 130 may receive the AVM image and the information of the surrounding vehicle by communicating with at least one surrounding vehicle located around the self-vehicle. In addition, the communicator 130 may support a communication interface for a differential global positioning system (DGPS) communication. Therefore, the communicator 130 may receive position information between the self-vehicle and the surrounding vehicle through the DGPS communication.

The storage 140 may store a set value to operate the AVM image providing apparatus and may store state information and a result for each operation. As an example, the storage 140 may store the AVM image of the self-vehicle and the AVM image of the surrounding vehicle and may store a composite image for the AVM image of the self-vehicle and the AVM image of the surrounding vehicle. In addition, an image composite algorithm for the composition of the AVM image may be stored in the storage 140.

The image converter 150 may generate the AVM image of the self-vehicle from the image of the self-vehicle surroundings photographed by the camera 120. At this time, the image converter 150 may perform view-converting of the image photographed from the surroundings of self-vehicle into a top view image to generate the AVM image.

In addition, the image converter 150 may convert the AVM image of the surrounding vehicle received through the communicator 130. At this time, the image converter 150 may recognize a relative position between the self-vehicle and the surrounding vehicle based on a position of the self-vehicle and the surrounding vehicle. As an example, the image converter 150 may move the AVM image of the surrounding vehicle based on the position of the self-vehicle by comparing the position and a direction of the self-vehicle with the position and a direction of the surrounding vehicle, and may rotate the AVM image of the surrounding vehicle based on the self-vehicle. When the direction of the surrounding vehicle is identical with the direction of the self-vehicle, the image converter may not rotate the AVM image of the surrounding vehicle.

The detector 160 may detect an overlapped area between the AVM image of the self-vehicle and the AVM image of the surrounding vehicle by comparing the AVM image of the self-vehicle with the AVM image of the surrounding vehicle.

The image compositor 170 may composite the AVM image of the self-vehicle and the AVM image of the surrounding vehicle based on the overlapped area detected by the detector 160. At this time, the image compositor 170 may assign a weight based on at least one of a linear component, a distance value, or a pixel value of the AVM image of the self-vehicle and the AVM image of the surrounding vehicle respectively, and may composite the AVM image of the self-vehicle and the AVM image of the surrounding vehicle based on a weighted-sum by calculating a weighted-sum of the assigned weight with respect to the area in which each AVM image is overlapped.

The image compositor 170 may calculate a coordinate of the AVM image composited from the weighted-sum with reference to the following [equation 1].

$${P}_{stitchedAVM} ( x , y ) = {Σ}_{k} {ω}_{k} ( x , y ) {P}_{overlappedAVM}^{k} ( x , y ) \qquad [ Equation 1 ]$$

Here, it is assumed that ω is 0≦ω≦1, ωₖ is Σωₖ≦1, and k is kε# of overlapped AVM, P is a coordinate value of the composited AVM image, P^{k} is an overlapped coordinate value of the AVM image of the surrounding vehicle, and ωₖ is a weight which is assigned to the corresponding image.

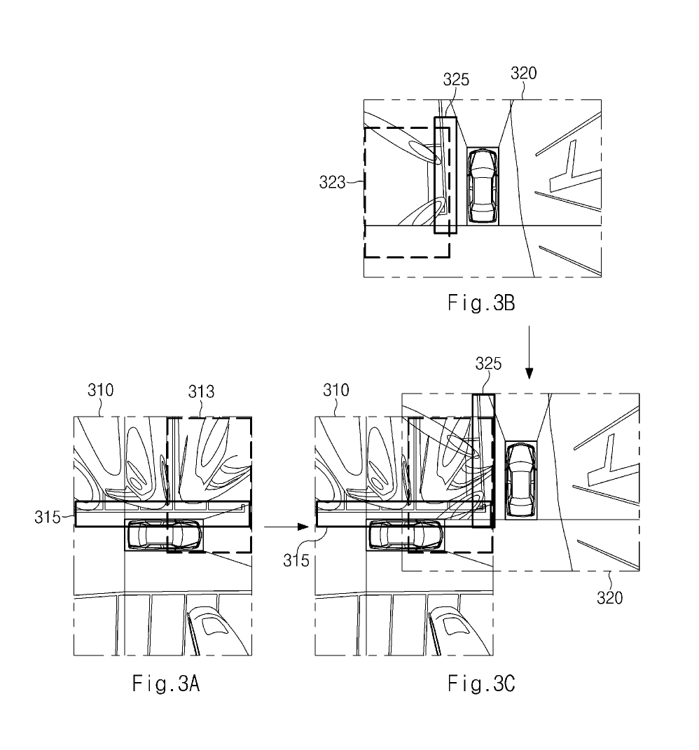

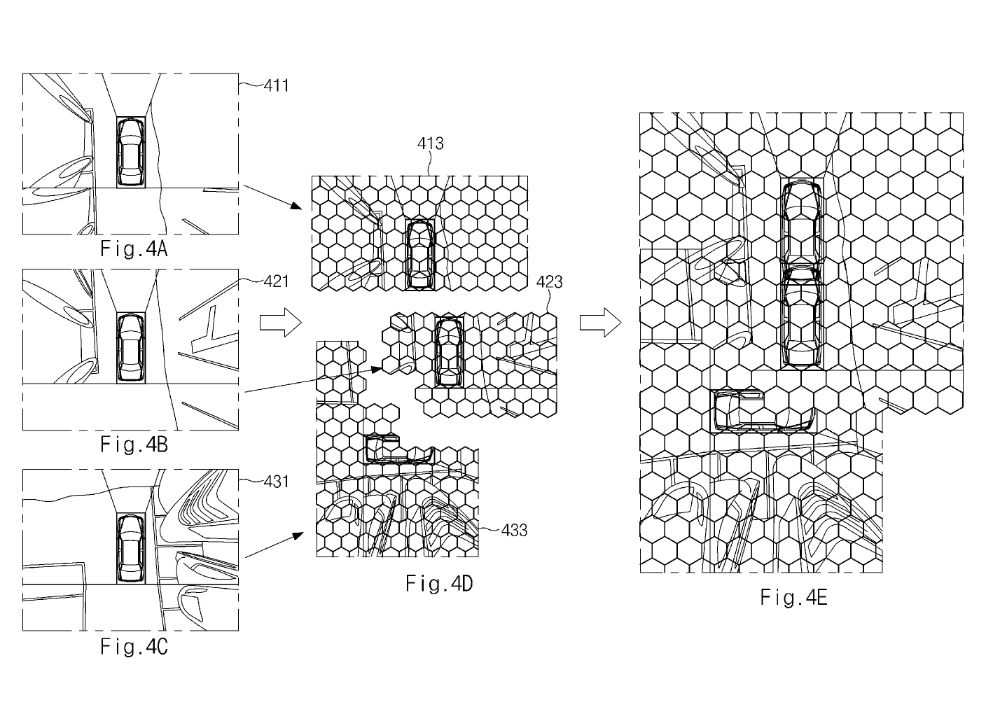

An operation of compositing an image according to the weight assigned to each AVM image will be described in detail with reference to FIGS. 3 and 4.

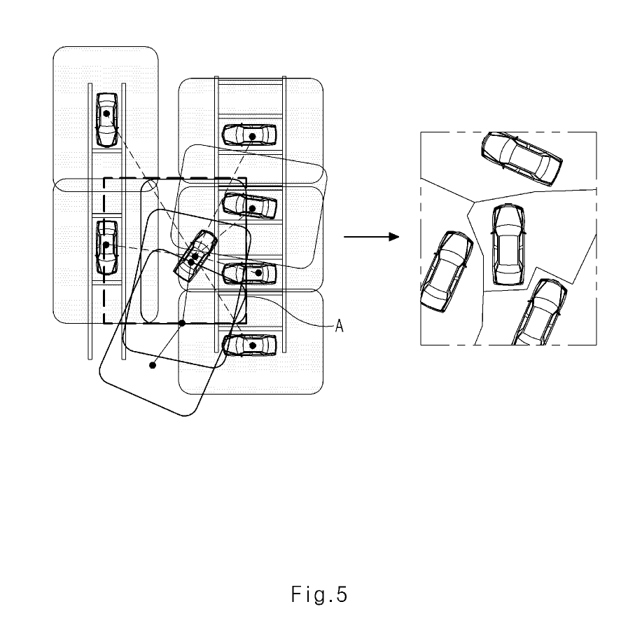

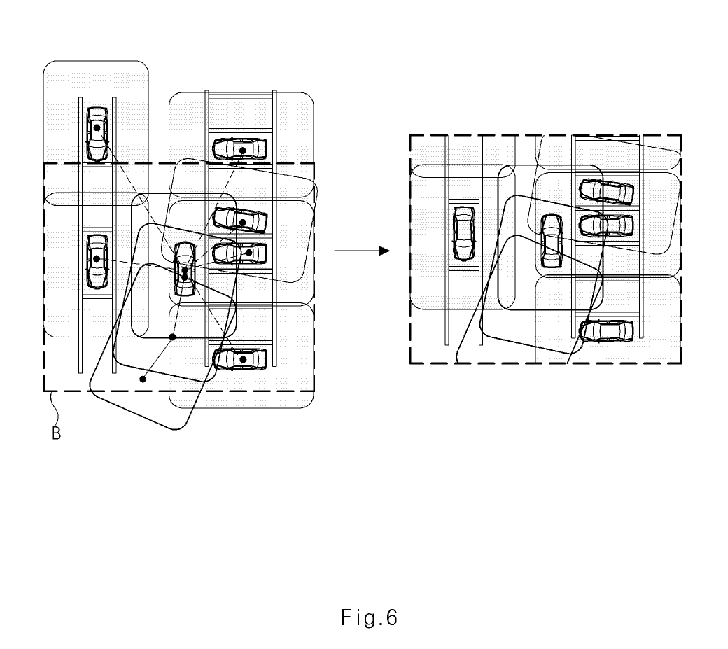

When compositing the AVM image of the self-vehicle and the AVM image of the surrounding vehicle, the image compositor 170 may composite the AVM image of the surrounding vehicle into the AVM image of the self-vehicle. Referring to FIG. 5, a visible range of the composited image may be identical to the AVM image of the self-vehicle. Referring to FIG. 6, the image compositor 170 may generate the AVM image composited to include all of each area of the AVM image of the self-vehicle and the AVM image of the surrounding vehicle. The AVM image composited by the image compositor 170 may be output through an output means (not shown) such as a monitor or a navigator mounted in the vehicle. Therefore, it is possible for a user to recognize a triangle zone of the self-vehicle and an image corresponding to the area other than the photographed area of the camera 120 equipped in the self-vehicle through the composited AVM image.

The image compositor 170 may composite each AVM image based on trajectory information of the corresponding vehicle when the image compositor 170 composites a successive AVM image and may composite the AVM image based on a feature point of each AVM image besides the overlapped area.

The image corrector 180 may correct a boundary area and a blank area of the AVM image composited by the image compositor 170. As an example, the image corrector 180 may process blending of the boundary area to minimize an image distortion in compositing each AVM image. The image corrector 180 may perform an interpolation or may process as an empty space the surrounding information of the corresponding vehicle with respect to the area where the size of the weighted-sum is small or information does not exist.

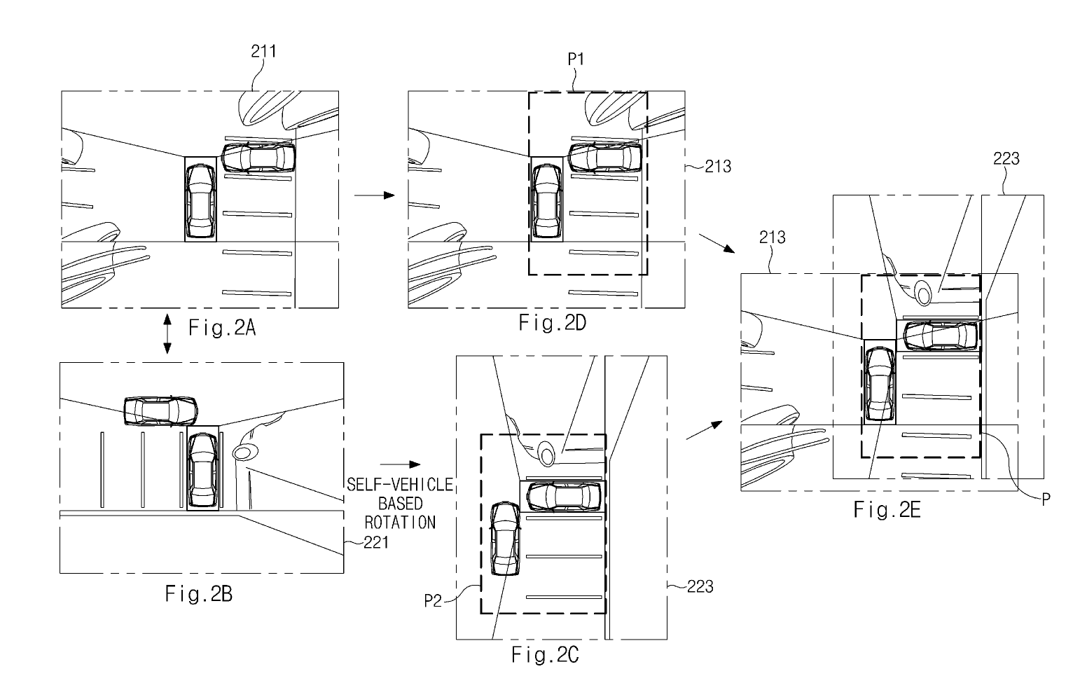

FIGS. 2 to 6 are exemplary diagrams explaining an image composition operation of an AVM image providing apparatus according to the present disclosure.

FIG. 2 illustrates an entire flow of an AVM image composition operation of an AVM image providing apparatus according to the present disclosure. FIG. 2A indicates an AVM image 211 of a self-vehicle, and FIG. 2B indicates an AVM image 221 of a surrounding vehicle. At this time, the AVM image providing apparatus rotates the image of the surrounding vehicle 221 illustrated in FIG. 2B based on a position and a direction of the self-vehicle as shown in FIG. 2C.

Then, the AVM image providing apparatus may detect an overlapped area (P1, P2) between each AVM image from the AVM image 211 of the self-vehicle and the AVM image 223 of the rotated surrounding vehicle as shown in FIGS. 2C and 2D. At this time, the AVM image providing apparatus may composite the AVM image 213 of the self-vehicle and the AVM image 223 of the surrounding vehicle as described in FIG. 2E, based on the AVM image 213 of the self-vehicle wherein the overlapped area is detected and the overlapped area (P1, P2) from the AVM image 223 of the surrounding vehicle. Therefore, the AVM image providing apparatus is able to provide the composited AVM image which has a wider visible range than the AVM image obtained from the self-vehicle.

FIG. 3 illustrates an operation of compositing each AVM image by assigning a weight to a linear component of the AVM image of the self-vehicle and the AVM image of the surrounding vehicle. FIG. 3A illustrates the AVM image of the self-vehicle, FIG. 3B illustrates the AVM image of the surrounding vehicle, and FIG. 3C illustrates the composited AVM image.

As illustrated in FIGS. 3A and 3B, the AVM image providing apparatus may detect the overlapped area 313, 323 between the AVM image of the self-vehicle 310 and the AVM image of the surrounding vehicle 320 respectively. At this time, the AVM image providing apparatus may assign the weight to the area 315 where the linear component is detected by detecting the linear component based on a floor surface of the AVM image of the self-vehicle 310. In addition, as illustrated in FIG. 3B, the AVM image providing apparatus may assign the weight to the area 325 where the linear component is detected, by detecting the linear component based on a floor surface of the AVM image 320 of the surrounding vehicle.

As illustrated in FIG. 3C, when compositing the AVM image of the self-vehicle 310 and the AVM image of the surrounding vehicle 320, the AVM image providing apparatus may composite each AVM image so that the linear component of the areas 315, 325 where the linear component is detected according to the weight assigned in the AVM image of the self-vehicle and the AVM image of the surrounding vehicle 320 may be maintained. Therefore, the composited AVM image may maintain the linear component of the AVM image of the self-vehicle and the AVM image of the surrounding vehicle.

FIG. 4 illustrates an operation of compositing each AVM image by assigning the weight to the area where a pixel of the AVM image of the self-vehicle and the AVM image of the surrounding vehicle is high. FIGS. 4A to C indicate each AVM image 411, 421, 431. The AVM image providing apparatus may split each AVM image 411, 421, 431 to a specific form respectively. For example, the AVM image providing apparatus may assign a weight to a plurality of hexagons according to a pixel value of each hexagon and may composite as described in FIG. 4C by extracting the image having the weight assigned to each AVM image is equal to or greater than a reference value.

FIGS. 4A to 4E illustrate that the AVM image is split into hexagons respectively, however, it is not limited thereto, and it is possible to change its size and shape accordingly.

FIG. 5 illustrates an example of compositing the AVM image of the surrounding vehicle into the AVM image of the self-vehicle. As illustrated in FIG. 5, the AVM image providing apparatus composites the AVM image of the surrounding vehicle into the AVM image of the self-vehicle in consideration of the weighted-sum in the state in which the AVM image of the surrounding vehicle is rotated, or its position is moved based on the position of the self-vehicle. At this time, the composited AVM image is identical to a photographing area A of the self-vehicle.

FIG. 6 illustrates an example of composition including all of a photographing area of the AVM image of the self-vehicle and the AVM image of the surrounding vehicle. As illustrated in FIG. 6, the composited AVM image is generated by matching an overlapped area between the AVM image of the self-vehicle and the AVM image of the surrounding vehicle based on the position of the self-vehicle. Therefore, it is possible to generate the composited AVM image corresponding to an area B including all visible areas of the AVM image of the self-vehicle and the AVM image of the surrounding vehicle. At this time, the consecutive AVM images according to the vehicle movement may be also composited as well as the AVM image at a corresponding time point.

The operation flow of the AVM image providing apparatus according to the above described present disclosure is described in more detail.

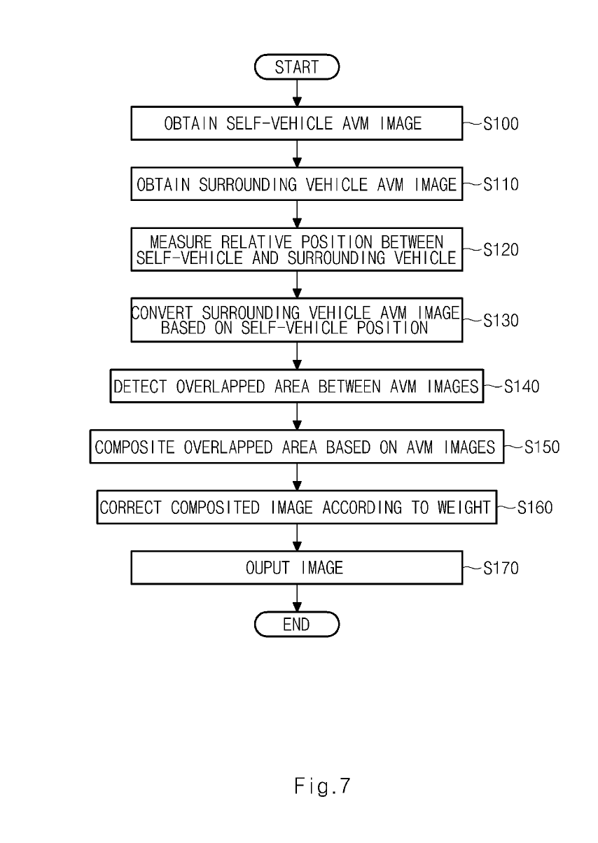

FIG. 7 is a flowchart illustrating an operation flow for an AVM image providing method according to the present disclosure. As illustrated in FIG. 7, the AVM image providing apparatus may obtain the AVM image of the self-vehicle from the image of the surrounding vehicle photographed by the camera (S100) and may obtain the AVM image and the information of the surrounding vehicle through a V2V communication with the surrounding vehicle (S110).

The AVM image providing apparatus measures a relative position between the self-vehicle and the surrounding vehicle based on the position and the direction information of the self-vehicle and the surrounding vehicle obtained through a DGPS module (S120). Then, the AVM image providing apparatus may convert the position and the direction of the AVM image of the surrounding vehicle based on the position of the self-vehicle according to the relative position measured at step S120 (S130). As an example, when moving directions of the self-vehicle and the surrounding vehicle are opposite to each other, the AVM image providing apparatus may rotate the AVM image of the surrounding vehicle 180 degrees to match to the direction of the self-vehicle.

The AVM image providing apparatus compares the AVM image of the self-vehicle obtained at step S100 with the AVM image of the surrounding vehicle where the position and the direction are converted at step S130. Step S140 detects the overlapped area between the AVM image of the self-vehicle and the AVM image of the surrounding vehicle and composites each AVM image based on the overlapped area detected at step S140 (S150).

At this time, the AVM image providing apparatus may calculate the weighted-sum of the weight assigned to each AVM image with respect to the area where the AVM image of the self-vehicle and the AVM image of the surrounding vehicle are overlapped, and, accordingly, may correct the image. In addition, the AVM image providing apparatus may correct an empty area of each AVM image or an area where the weighted-sum is small.

The AVM image composited by the AVM image providing apparatus may be output through an output means such as a monitor or a navigation equipped in the self-vehicle so that a user may verify thereof (S170).

The present disclosure is able to provide an AVM image even in an area which is difficult to recognize from a self-vehicle by providing an AVM image composited with an AVM image of a self-vehicle based on an AVM image and information obtained from a surrounding vehicle.

Although exemplary embodiments of the disclosure have been described in detail hereinabove, it should be clearly understood that many variations and modifications of the basic inventive concepts herein taught which may appear to those skilled in the present art will still fall within the spirit and scope of the disclosure, as defined in the appended claims.

What is claimed is:

1. An apparatus for providing an around view monitoring (AVM) image, the apparatus comprising:
a camera which photographs an image of a self-vehicle's surroundings;
a communicator which transmits and receives a signal with a surrounding vehicle, and receives an AVM image and surrounding information from the surrounding vehicle;
an image converter which generates an AVM image of a self-vehicle from the image photographed by the camera, and converts the AVM image of the surrounding vehicle based on a position of the self-vehicle by determining a relative position between the self-vehicle and the surrounding vehicle;
a detector which detects an overlapped area between the AVM image of the self-vehicle and the AVM image of the surrounding vehicle; and
an image compositor which composites the AVM image of the self-vehicle and the AVM image of the surrounding vehicle by matching the overlapped area between the AVM image of the self-vehicle and the AVM image of the surrounding vehicle.

2. The apparatus of claim 1, wherein the image converter compares the position and a direction of the self-vehicle with a position and a direction of the surrounding vehicle, moves a position of the AVM image of the surrounding vehicle to match based on the position of the self-vehicle, and rotates the AVM image of the surrounding vehicle to match based on the direction of the self-vehicle.

3. The apparatus of claim 1, wherein the image compositor composites the AVM image of the self-vehicle and the AVM image of the surrounding vehicle by assigning a weight to an area where a linear component exists on a floor surface detected from the AVM image of the self-vehicle and the AVM image of the surrounding vehicle.

4. The apparatus of claim 1, wherein the image compositor composites the AVM image of the self-vehicle and the AVM image of the surrounding vehicle based on an area to which a weight is assigned by assigning the weight to a short distance area within a distance from the camera based on a camera mounting position of the self-vehicle and surrounding vehicle.

5. The apparatus of claim 1, wherein the image compositor composites the AVM image of the self-vehicle and the AVM image of the surrounding vehicle based on an area to which a weight is assigned by assigning the weight to an area having a pixel value which is equal to or greater than a reference value and by comparing a pixel of the AVM image of the self-vehicle with a pixel of the AVM image of the surrounding vehicle.

6. The apparatus of claim 1, wherein the AVM image composited by the image compositor is obtained by compositing the AVM image of the surrounding vehicle within an AVM image range of the self-vehicle.

7. The apparatus of claim 1, wherein the AVM image composited by the image compositor comprises both of an AVM image range of the self-vehicle and an AVM image range of the surrounding vehicle.

8. The apparatus of claim 1, further comprising:
an image corrector which corrects a boundary area and an empty area of each AVM image from the composited AVM image.

9. A method for providing an AVM image, the method comprising:
photographing an image of a self-vehicle's surroundings;
receiving an AVM image of a surrounding vehicle and surrounding information by communicating with the surrounding vehicle;
converting the AVM image of the surrounding vehicle to match based on a position of the self-vehicle by determining a relative position between the self-vehicle and the surrounding vehicle;
compositing an AVM image of the self-vehicle and the AVM image of the surrounding vehicle based on an overlapped area by detecting the overlapped area between the AVM image of the self-vehicle generated from the image of the self-vehicle's surroundings and the AVM image of the surrounding vehicle; and
correcting a boundary area and an empty area of the composited AVM image.

10. The method of claim 9, wherein the compositing of the AVM image includes assigning a weight based on at least one of a linear component, a distance, or a pixel of the AVM image of the self-vehicle and the AVM image of the surrounding vehicle respectively.

11. The method of claim 10, wherein the compositing of the AVM image further comprises:
calculating a weighted-sum of an area to which the weight is assigned on the AVM image of the self-vehicle and the AVM image of the surrounding vehicle; and
the AVM image of the self-vehicle and the AVM image of the surrounding vehicle are composited from the weighted-sum.
